(19) United States
(12) Patent Application Publication
(10) Pub. No.: US 2017/0335209 A1
(43) Pub. Date: Nov. 23, 2017

(54) APPARATUS AND METHOD FOR MIXING HYDROGEN SULFIDE SCAVENGER WITH CRUDE OIL WITHIN A PIPELINE

(71) Applicant: BAKER HUGHES, A GE COMPANY, LLC, Houston, TX (US)

(72) Inventors: EMANUEL GUIRGUIS RASMY MARSIS, KATY, TX (US); PATRICK RODGERS, HOUSTON, TX (US); TUDOR CONSTANTIN IONESCU, HOUSTON, TX (US)

(73) Assignee: BAKER HUGHES, A GE COMPANY, LLC, Houston, TX (US)

(21) Appl. No.: 15/397,510

(22) Filed: Jan. 3, 2017

Related U.S. Application Data
(60) Provisional application No. 62/274,651, filed on Jan. 4, 2016.

(51) Int. Cl. C10G 75/02; F17D 3/12; F15D 1/02

(52) U.S. Cl. CPC C10G 75/02; F15D 1/025; F17D 3/12

(57) ABSTRACT

An apparatus and method for mixing a hydrogen sulfide scavenger with crude oil within a pipeline are disclosed. The hydrogen sulfide scavenger and the crude oil can be passed through a plurality of baffles disposed at spaced apart locations within the pipeline. The baffles can be used as an in-flow static mixer to produce increased circulation and flow speed which results in improved mixing of the hydrogen sulfide scavenger and crude oil.

### RELATED APPLICATIONS

This application claims the benefit, and priority benefit, of U.S. Provisional Patent Application Ser. No. 62/274,651, filed Jan. 4, 2016, the disclosure and contents of which are incorporated by reference herein in their entirety.

### BACKGROUND

### Description of the Related Art

Crude oil within an oil flow pipeline can contain undesirable amounts of hydrogen sulfide. Hydrogen sulfide is both toxic and corrosive, and its removal from the crude oil is often sought after.

It is known in the art to use a hydrogen sulfide scavenger to remove the hydrogen sulfide, thus “sweetening” the crude oil. Typical hydrogen sulfide scavengers include triazines, aldehydes, solid scavengers and oxidizing chemicals.

Static mixers have been utilized inside the pipeline to facilitate mixing of the hydrogen sulfide scavenger with the crude oil. However, these previous mixers have not achieved the desired amount of mixing.

Improvements in this field of technology are therefore desired.

### SUMMARY

In certain illustrative embodiments, an apparatus for mixing a hydrogen sulfide scavenger with crude oil within an oil flow pipeline is provided. The apparatus can include a plurality of baffles disposed at spaced apart locations within the pipeline. The plurality of baffles can have flow openings formed therein such that a mixture of the hydrogen sulfide scavenger and the oil may pass through the openings. The apparatus can also include a flow inlet, a flow outlet and a jacket, wherein the plurality of baffles is disposed at spaced apart locations within the jacket.

In certain illustrative embodiments, a method of mixing a hydrogen sulfide scavenger with crude oil within an oil flow pipeline is also provided. A mixture of the hydrogen sulfide scavenger and the oil can be passed through a plurality of baffles. The baffles can be disposed at spaced apart locations within the pipeline. One or more of the baffles can have a flow opening formed therein such that flow may pass through the flow opening.

In certain illustrative embodiments, at least two of the baffles can be adjacently disposed within the pipeline and have flow openings that are alternating in their direction of orientation. Also, at least two of the baffles can be adjacently disposed within the pipeline and have flow openings that are substantially opposite in their direction of orientation.

In certain illustrative embodiments, at least two of the baffles can be adjacently disposed within the pipeline and have a chamber formed therebetween such that mixing and flow circulation of the hydrogen sulfide scavenger and oil can occur substantially within the chamber.

In certain illustrative embodiments, one or more of the baffles can have a circular or oval cross section. The jacket can have an inner space with a circular or oval cross section, and the baffles can be disposed within the jacket and have cross sections that correspond in size and shape to the cross section of the jacket. The at least two baffles can adjacently disposed within the pipeline and have flow openings formed in the circular or oval cross section that are alternating or substantially opposite in their direction of orientation.

In certain illustrative embodiments, one or more of the baffles can have a circular or oval cross section. The pipeline can have an inner space with a circular or oval cross section, and the baffles can be disposed directly within the pipeline and have cross sections that correspond in size and shape to the cross section of the pipeline.

While the presently disclosed subject matter will be described in connection with the preferred embodiment, it will be understood that it is not intended to limit the presently disclosed subject matter to that embodiment. On the contrary, it is intended to cover all alternatives, modifications, and equivalents, as may be included within the spirit and the scope of the presently disclosed subject matter as defined by the appended claims.

### BRIEF DESCRIPTION OF THE DRAWINGS

FIG. 1 is a computer simulated drawing of a pipeline without any mixer.

FIG. 2A is a computer simulated drawing of a Koflo® 12 static mixer.

FIG. 2B is a computer simulated drawings of a Koflo® 12 static mixer.

FIG. 2C is a computer simulated drawing of a Koflo® 12 static mixer disposed within a pipeline.

FIG. 3A is a computer simulated drawing of a coil and nozzle mixer disposed within a pipeline according to an embodiment of the presently disclosed subject matter.

FIG. 3B is a computer simulated drawing of a coil and nozzle mixer according to an embodiment of the presently disclosed subject matter.

FIG. 4 is a computer simulated drawing of a baffle mixer within a pipeline according to an embodiment of the presently disclosed subject matter.

FIG. 5 shows simulation results for an embodiment of the presently disclosed subject matter.

FIG. 6 shows simulation results for an embodiment of the presently disclosed subject matter.

FIG. 7 shows simulation results for an embodiment of the presently disclosed subject matter.

FIG. 8 shows simulation results for an embodiment of the presently disclosed subject matter.

FIG. 9 shows simulation results for an embodiment of the presently disclosed subject matter.

### DETAILED DESCRIPTION

Disclosed herein are various illustrative embodiments of an apparatus and method for mixing a hydrogen sulfide scavenger with crude oil within a pipeline.

In certain illustrative embodiments, the hydrogen sulfide scavenger and the crude oil can be passed through a plurality of baffles disposed at spaced apart locations within the pipeline. The baffles can be used as an in-flow static mixer to produce increased circulation and flow speed which results in improved mixing of the hydrogen sulfide scavenger and crude oil.

In certain illustrative embodiments of a mixer 10 according to the presently disclosed subject matter, mixer 10 has a jacket 20, an inlet opening 30 through which one or more fluids may be introduced and an outlet opening 40 through which one or more fluids may exit.

A plurality of baffles 50 are disposed at spaced apart locations within the mixer 10. Each baffle 50 has a generally circular or oval cross section, which corresponds to the interior circular or oval cross section of the inner section of jacket 20.

One or more of the plurality of baffles 50 have flow openings 60 formed therein that allow materials to flow through, or over, baffles 50. For example, when mixer 10 is disposed within a pipeline containing crude oil and a hydrogen sulfide scavenger, the mixture of the hydrogen sulfide scavenger and the crude oil may pass through flow openings 60 as it makes its way through mixer 10.

In certain illustrative embodiments, one or more of baffles 50 can have a circular or oval cross section. Jacket 20 can have an inner space with a circular or oval cross section, and baffles 50 can be disposed within jacket 20 and have cross sections that correspond in size and shape to the cross section of jacket 20.

In certain illustrative embodiments, at least two of baffles 50 can be adjacently disposed within mixer 10 and have flow openings 60 that are alternating in their direction of orientation. As used herein, the term “alternating” means on reverse ends of adjacent baffles. For example, for a pair of adjacent baffles 50 each having a circular or oval shape with a diameter formed thereacross, flow openings 60 are disposed on either end of the diameters of the adjacent baffles 50.

In certain illustrative embodiments, at least two of baffles 50 can be adjacently disposed within mixer 10 and have flow openings 60 that are substantially opposite in their direction of orientation. As used herein, the term “substantially opposite” means on approximately 180 degree reverse ends of adjacent baffles. For example, for a pair of adjacent baffles 50 each having a circular or oval shape with a diameter formed thereacross, flow openings 60 are disposed on either end of the diameters of the adjacent baffles 50 and at approximately 180 degrees from each other.

In general, flow openings 60 can be oriented within the pipeline or mixer 10 to provide the desired and rate of mixing for the hydrogen sulfide scavenger and crude oil.

In certain illustrative embodiments, baffles 50 can be adjacently disposed within the jacket 20 and have a chamber 70 formed therebetween such that mixing and flow circulation of the hydrogen sulfide scavenger and crude oil can occur within chamber 70. Thus, in the case of three or more baffles 50, mixer 10 will have two or more chambers 70 or mixing sections where mixing can occur, between the adjacent baffles 50.

For example, in certain illustrative embodiments mixer 10 has six baffles 50 disposed therein. The first, third and fifth baffles 50 have flow openings 60 that are oriented towards the top of baffle 50, while the second, fourth and sixth baffles 50 have flow openings 60 that are oriented towards the bottom of baffle 50. Thus, there are five chambers 70 within which mixing can occur. The orientation of baffles 50 and flow openings 60 within mixer 10 provides enhanced circulation of the flow inside chambers 70 between baffles 50.

In other illustrative embodiments, a plurality of baffles 50 are disposed at spaced apart locations directly within the pipeline. In other words, there is no jacket 20 to surround the baffles 50. Each baffle 50 has a generally circular shape, which corresponds to the interior circular shape of the pipeline. The pipeline can have an inner space with a circular or oval cross section, and baffles 50 can be disposed within the pipeline and have cross sections that correspond in size and shape to the cross section of the pipeline.

The hydrogen sulfide scavenger can be added to the oil at any location within the pipeline or mixer 10 that facilitates the desired amount of mixing. For example, the hydrogen sulfide scavenger can be added to the oil before the oil reaches the first in sequence of the adjacently positioned baffles 50, or alternatively, while the oil is flowing between or through any of the subsequently positioned baffles 50. Further, the hydrogen sulfide scavenger can be inserted into the pipeline or mixer 10 via injection or any other means that would be recognized by one of ordinary skill in the art.

To facilitate a better understanding of the presently disclosed subject matter, the following prophetic examples of certain aspects of certain embodiments are given. In no way should the following prophetic examples be read to limit, or define, the scope of the presently disclosed subject matter.

### EXAMPLES

A prophetic computer simulation was performed to determine the predicted performance of a mixer according to the presently disclosed subject matter.

A three dimensional (3D) computer model was built for a 120 foot long section of pipeline. A discrete phase model (DPM) was first proposed to simulate injecting the hydrogen sulfide scavenger chemical and tracking its concentration in the pipeline. However, it was discovered that the DPM model was limited because it could not effectively simulate the transient behavior of the chemical and it assumed no mass diffusivity between the chemical and its flow.

Species transport was determined to be a better model than DPM for purposes of mixing visualization. Therefore, a species transport model was used and the mass diffusivity was chosen carefully and kept constant across different simulations for comparison purposes.

A 3-D cumulative distribution function (CFD) geometry was generated for the geometry of the 120 foot long section of pipeline with inclusion of boundary layer mesh. The chemical was injected for 0.1 seconds and traced transiently across the flow line. A surface was created at 35 feet into the flow line and was used to monitor the concentration of the chemical passing through the pipeline over time.

Four different geometries were simulated and compared within the pipeline: (i) no mixer; (ii) a Koflo® 12 static mixer (generated based on 2D drawings and pictures provided by the supplier); (iii) a proposed coil and nozzle mixer design, wherein a nozzle was added to accelerate the flow locally to create more turbulence, and a coil was added to accelerate the flow and provide a high swirl velocity to improve the mixing; and (iv) a baffle mixer according to the presently disclosed subject matter. Each of the different geometries was simulated transiently using the species model.

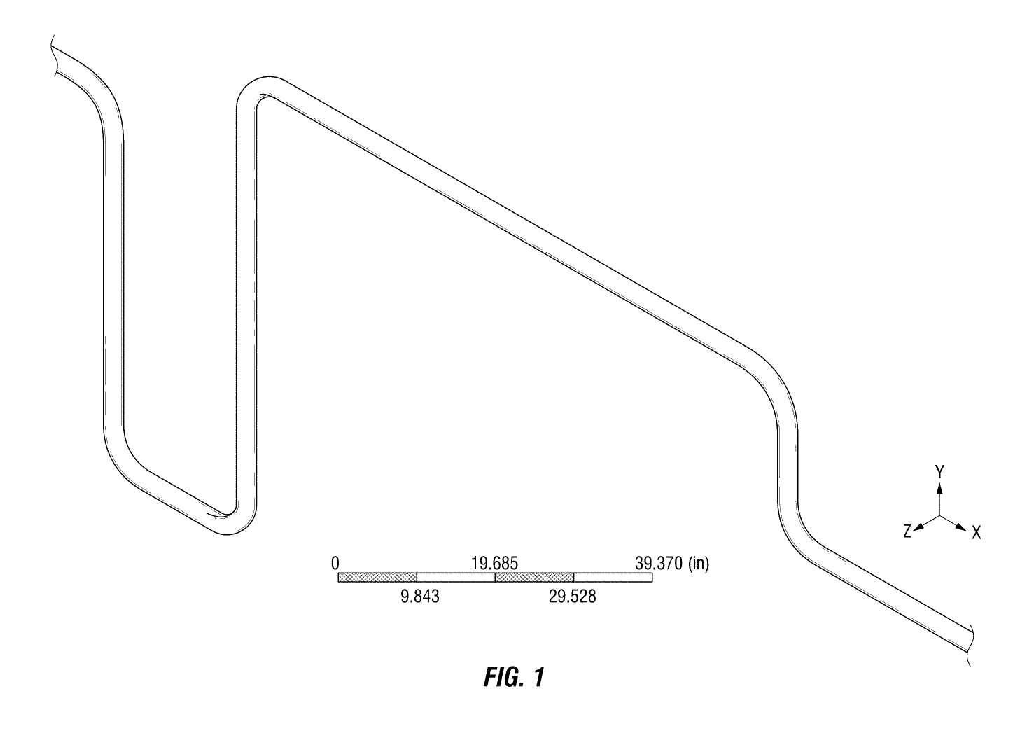

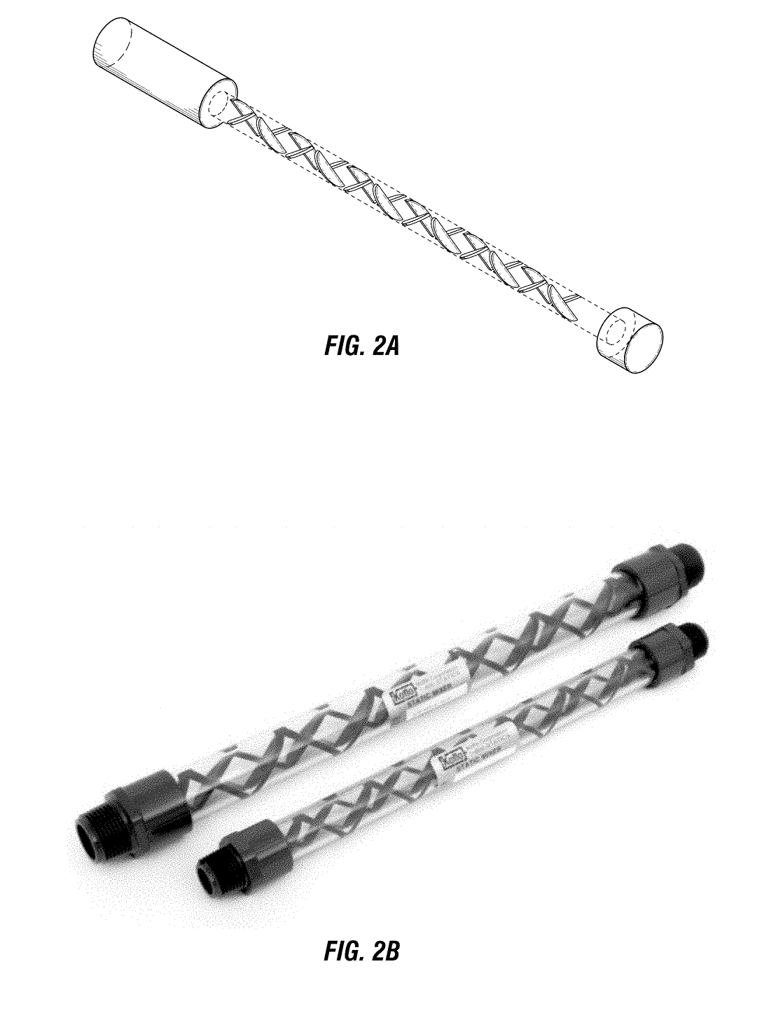

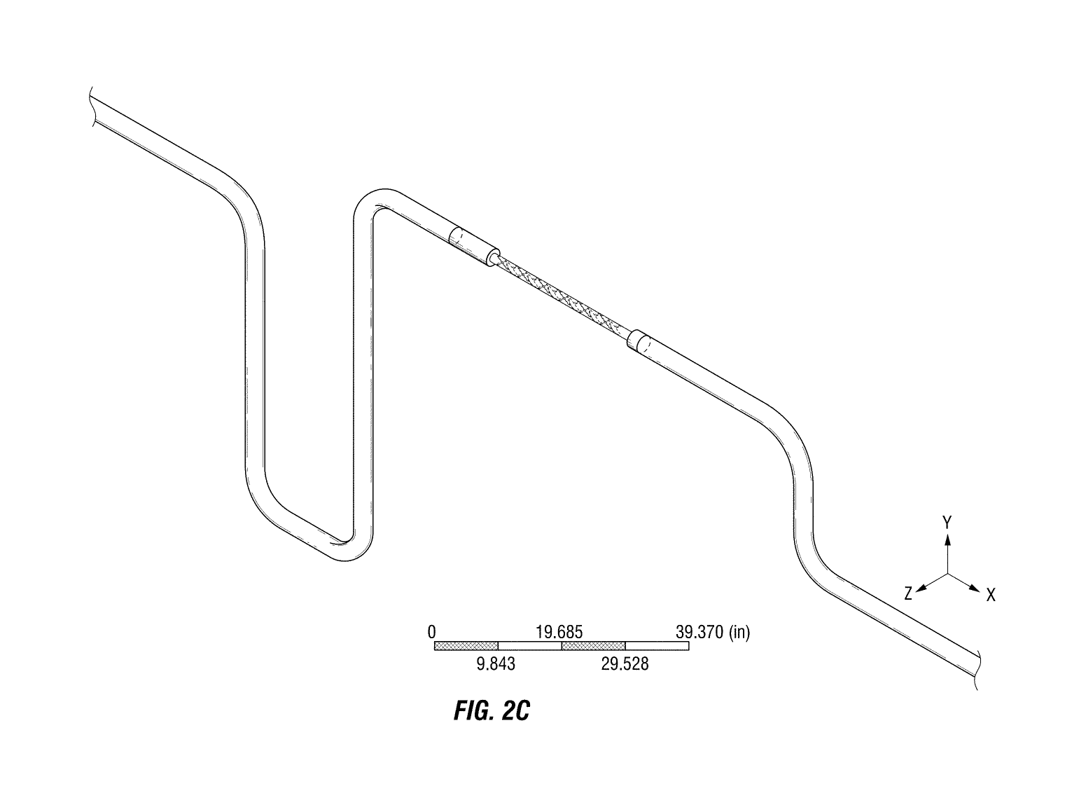

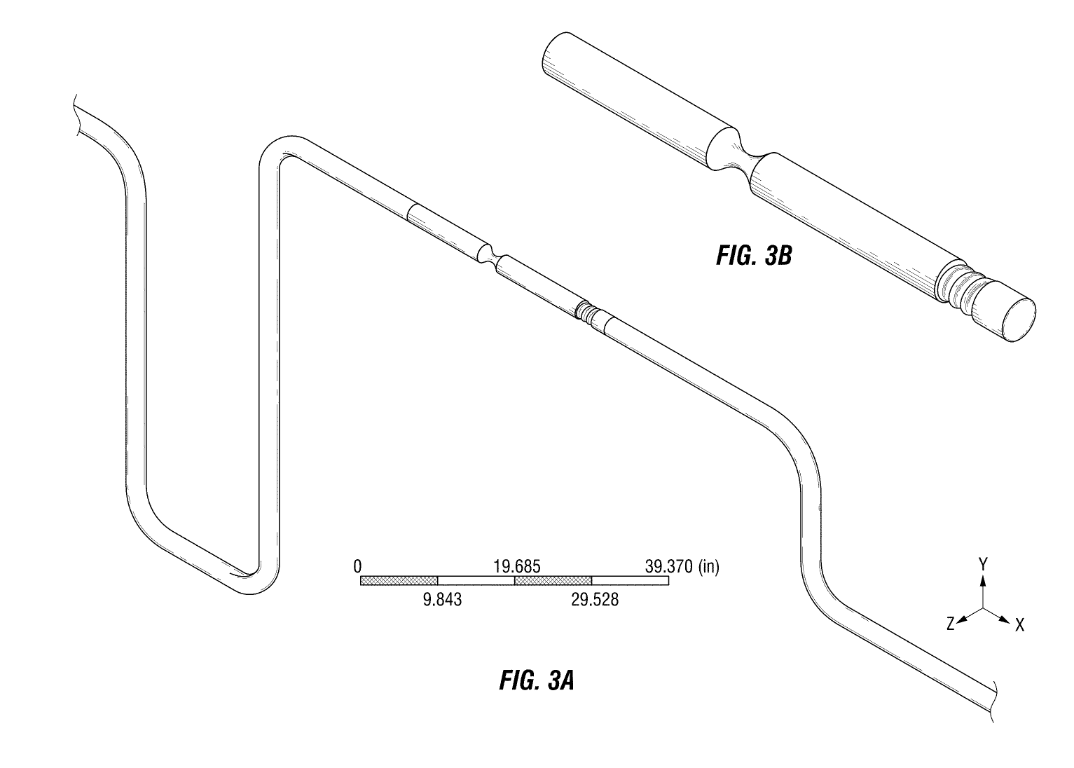

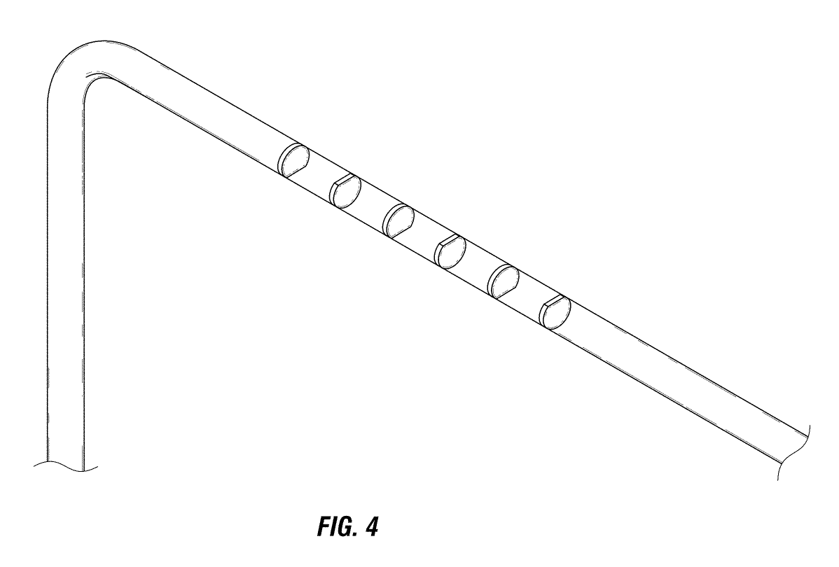

FIG. 1 shows the computer simulated pipeline without any mixer. FIGS. 2A-2C show the computer simulated Koflo® 12 static mixer both alone and within the computer simulated pipeline. FIGS. 3A and 3B show the proposed coil and nozzle mixer design both alone and within computer simulated pipeline. FIG. 4 shows the baffle mixer within the computer simulated pipeline according to an embodiment of the presently disclosed subject matter.

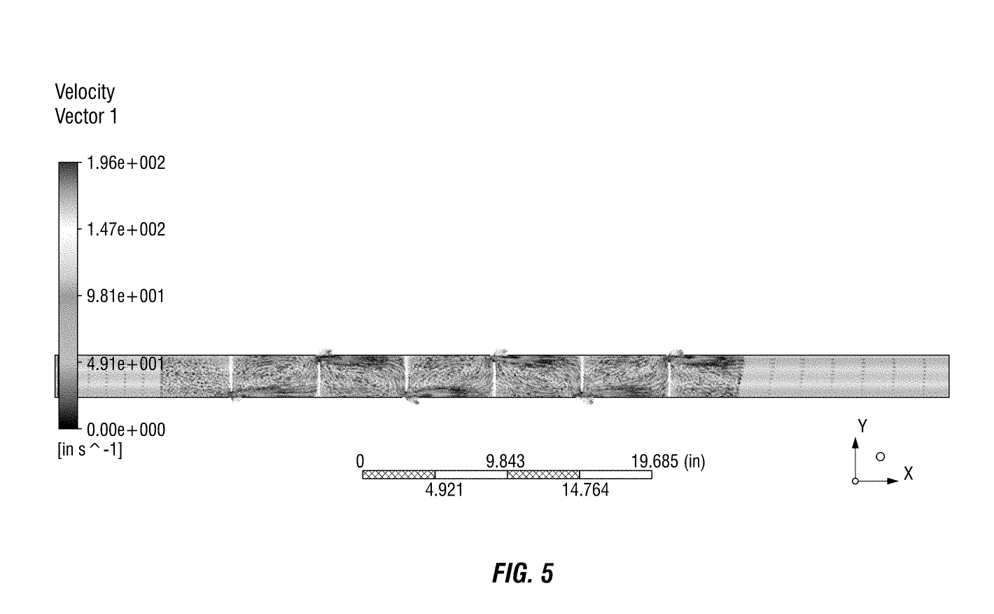

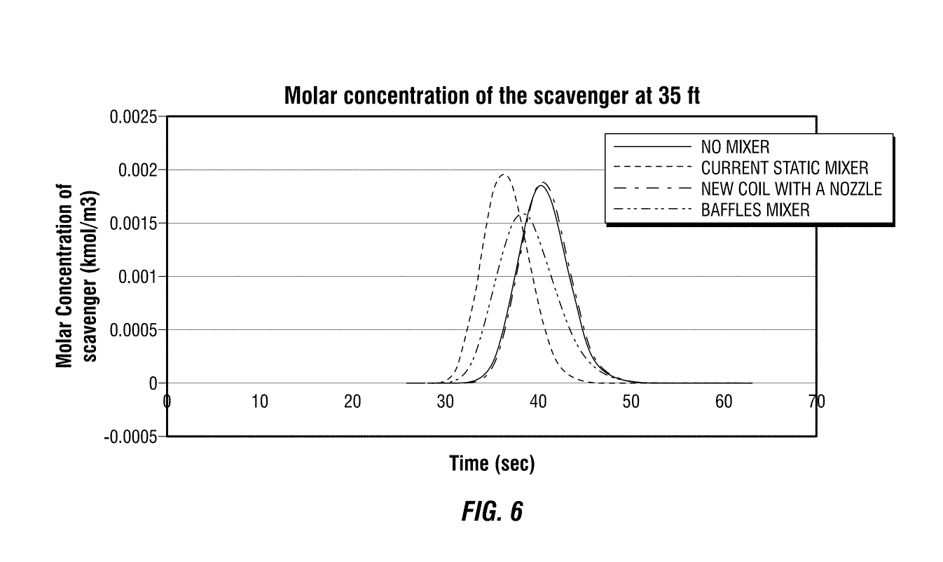

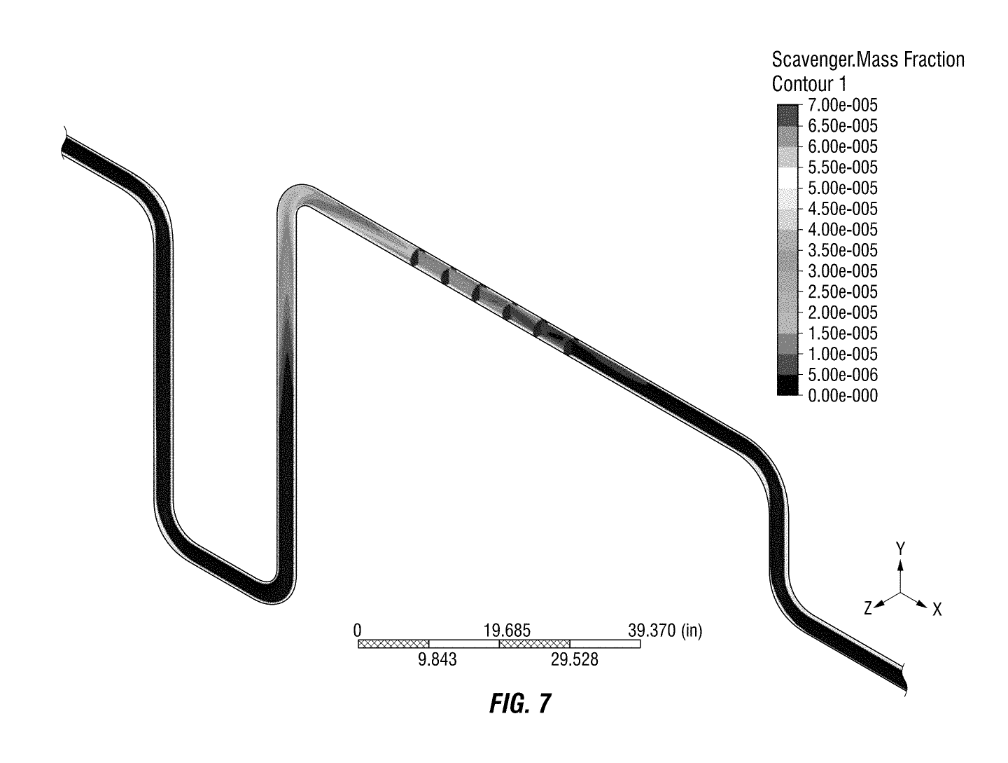

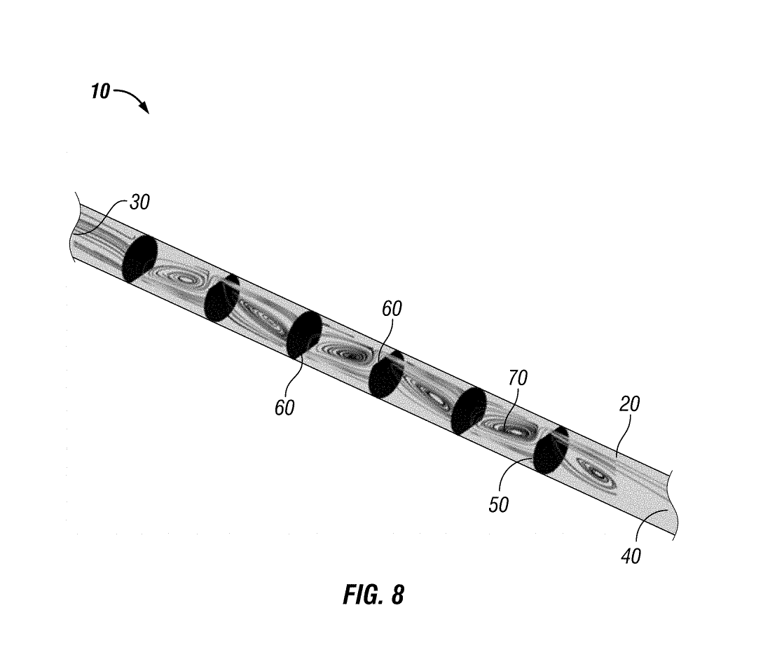

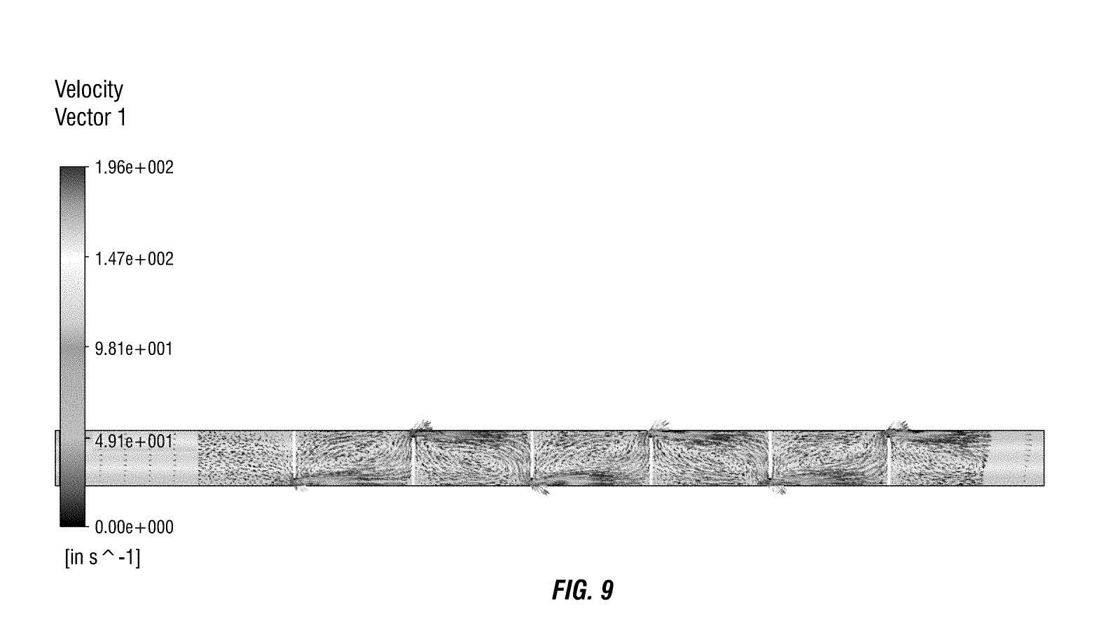

FIGS. 5-9 show various simulation results. According to these results, the baffle design provides better mixing than the other three designs. For example, there is approximately a 14 psi pressure drop in the fluid as it passes through the baffle mixer, in the simulated embodiment.

Current static mixers are not providing adequate mixing due to the low flow speed and the fact that the flow tends to maneuver between the mixer's sections without creating enough turbulence to promote the desired mixing. In contrast, the baffle mixer of the presently disclosed subject matter provides good mixing and circulation of the flow inside the chambers between the baffles. The baffles provide for improved flow distribution within the pipeline and improved mixing of the hydrogen sulfide scavenger and the oil. The baffles force the hydrogen sulfide scavenger and the oil to move from side to side within the pipeline.

In practice, the details of the geometry of the baffles can be determined using design optimization based on the flow rate and the pipe diameter. Thus, the size and dimensions will be different from case to case.

In certain illustrative embodiments, baffles 50 can be used as an in-flow static mixer to produce increased circulation and flow speed which results in improved mixing of one or more production chemicals with the crude oil.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter.

Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the appended claims.

What is claimed is:

1. An apparatus for mixing hydrogen sulfide scavenger with crude oil within an oil flow pipeline, the apparatus comprising: a plurality of baffles disposed at spaced apart locations within the pipeline, wherein the plurality of baffles have flow openings formed therein such that a mixture of the hydrogen sulfide scavenger and the crude oil may pass through the openings.

2. The apparatus of claim 1, wherein the apparatus further comprises a flow inlet, a flow outlet and a jacket, and wherein the plurality of baffles is disposed at spaced apart locations within the jacket.

3. The apparatus of claim 1, wherein at least two of the baffles are adjacently disposed within the pipeline and have flow openings that are alternating in their direction of orientation.

4. The apparatus of claim 1, wherein at least two of the baffles are adjacently disposed within the pipeline and have flow openings that are substantially opposite in their direction of orientation.

5. The apparatus of claim 1, wherein at least two of the baffles are adjacently disposed within the pipeline and have a chamber formed therebetween such that mixing and flow circulation of the hydrogen sulfide scavenger and oil can occur substantially within the chamber.

6. The apparatus of claim 1, wherein one or more of the baffles has a circular or oval cross section.

7. The apparatus of claim 2, wherein the jacket has an inner space with a circular or oval cross section and the baffles disposed within the jacket have cross sections that correspond in size and shape to the cross section of the jacket.

8. The apparatus of claim 6, wherein at least two of the baffles are adjacently disposed within the pipeline and have flow openings formed in the circular or oval cross section that are alternating in their direction of orientation.

9. The apparatus of claim 6, wherein at least two of the baffles are adjacently disposed within the pipeline and have flow openings formed in the circular or oval cross section that are substantially opposite in their direction of orientation.

10. A method of mixing a hydrogen sulfide scavenger with oil within an oil flow pipeline, the method comprising: passing a mixture of the hydrogen sulfide scavenger and the oil through a plurality of baffles, the baffles being disposed at spaced apart locations within the pipeline, wherein one or baffles has a flow opening formed therein such that flow may pass through the flow opening.

11. An apparatus for mixing one or more production chemicals with crude oil within an oil flow pipeline, the apparatus comprising: a plurality of baffles disposed at spaced apart locations within the pipeline, wherein the plurality of baffles have flow openings formed therein such that a mixture of the production chemicals and the crude oil may pass through the openings.

12. The apparatus of claim 11, wherein the apparatus further comprises a flow inlet, a flow outlet and a jacket, and wherein the plurality of baffles is disposed at spaced apart locations within the jacket.

13. The apparatus of claim 11, wherein at least two of the baffles are adjacently disposed within the pipeline and have flow openings that are alternating in their direction of orientation.

14. The apparatus of claim 11, wherein at least two of the baffles are adjacently disposed within the pipeline and have flow openings that are substantially opposite in their direction of orientation.

15. The apparatus of claim 11, wherein at least two of the baffles are adjacently disposed within the pipeline and have a chamber formed therebetween such that mixing and flow circulation of the production chemicals and oil can occur substantially within the chamber.

16. The apparatus of claim 11, wherein one or more of the baffles has a circular or oval cross section.

17. The apparatus of claim 12, wherein the jacket has an inner space with a circular or oval cross section and the baffles disposed within the jacket have cross sections that correspond in size and shape to the cross section of the jacket.

18. The apparatus of claim 16, wherein at least two of the baffles are adjacently disposed within the pipeline and have flow openings formed in the circular or oval cross section that are alternating in their direction of orientation.

19. The apparatus of claim 16, wherein at least two of the baffles are adjacently disposed within the pipeline and have flow openings formed in the circular or oval cross section that are substantially opposite in their direction of orientation.

20. A method of mixing one or more production chemicals with oil within an oil flow pipeline, the method comprising: passing a mixture of the production chemicals and the oil through a plurality of baffles, the baffles being disposed at spaced apart locations within the pipeline, wherein one or baffles has a flow opening formed therein such that flow may pass through the flow opening.
